(19) United States
(12) Patent Application Publication
(10) Pub. No.: US 2017/0028785 A1
(43) Pub. Date: Feb. 2, 2017

(54) METHOD OF MANUFACTURING PNEUMATIC TIRE AND PNEUMATIC TIRE

(71) Applicant: TOYO TIRE & RUBBER CO., LTD., Osaka (JP)

(72) Inventor: Seiji Yokomakura, Osaka (JP)

(73) Assignee: TOYO TIRE & RUBBER CO., LTD., Osaka (JP)

(21) Appl. No.: 15/222,108

(22) Filed: Jul. 28, 2016

(30) Foreign Application Priority Data
Jul. 29, 2015 (JP) 2015-150095

(51) Int. Cl. B60C 9/20; B29D 30/30

(52) U.S. Cl. CPC B60C 9/20; B29D 30/3042; B60C 2009/2016; B60C 2009/2061; B60C 2200/06

(57) ABSTRACT

A method of manufacturing a pneumatic tire comprising a belt which is wound with a belt-under diameter D outside a carcass ply in a tire-radial direction, includes preparing a strip-like rubber-coated cord member where a plurality of belt cords which are arranged approximately parallel are coated with rubber and a width of the cord member in a lateral direction is πD sin θ. The cord member is cut at the cord angle θ with respect to a longitudinal direction to cut out a belt forming member having a parallelogram which includes circumferential direction sides extending in a tire circumferential direction in a wound state and formed as cut portions and inclined sides extending parallel to the belt cord and defined as both side portions of the cord member. The belt forming member is wound into a circular cylindrical shape and joined the inclined sides which face each other to each other.

### CROSS-REFERENCE TO RELATED APPLICATION

This application claims priority of Japanese Patent Application No. 2015-150095 filed on Jul. 29, 2015, the content of which is incorporated herein by reference.

### BACKGROUND OF THE INVENTION

Technical Field

The present invention relates to a method of manufacturing a pneumatic tire and a pneumatic tire.

Related Art

In a pneumatic tire, a belt layer is disposed between a carcass ply and a tread portion for suppressing a growth of the tire in a radial direction. A plurality of belts are disposed in the belt layer in a state where an inclination angle of a belt cord with respect to a tire circumferential direction (cord angle) takes various values corresponding to the respective belts (see Japanese Patent No. 5182455, for example).

Conventionally, as a method of forming such a belt, there has been known a method shown in FIG. 6A to FIG. 6E. That is, first, referring to FIG. 6A, a strip-like rubber-coated cord member (referred to as “raw fabric”) 110 is prepared where a plurality of belt cords 100a which are arranged approximately parallel to a longitudinal direction are coated with rubber. Next, as shown in FIG. 6B, the raw fabric 110 is sequentially cut in a direction which intersects with the longitudinal direction of the raw fabric 110 at a cord angle θ100 thus cutting out short primary plies 111.

Next, referring to FIG. 6C, a plurality of primary plies 111 are sequentially joined to each other at a portion 111a (non-cut portions) which was side portions of the raw fabric 110, and thus a long secondary ply 112 is formed. Next, as shown in FIG. 611), a belt forming member 113 is cut out from the secondary ply 112 by an amount of a belt-under circumferential direction length π corresponding to a belt-under diameter D. Then, as shown in FIG. 6E, a belt 100 is formed by the belt forming member 113 wound in a circular cylindrical shape. In the belt 100 formed in this manner, the belt cord 100a extends in a direction inclined with respect to the tire circumferential direction at a cord angle θ100.

Further, as another method, there has been also known a method where a belt is formed by continuously winding a strip-like rubber-coated cord member which is formed by one or a plurality of cords coated with rubber in a spiral manner see JP 4-229238 A, for example).

### SUMMARY OF THE INVENTION

In the former method, the secondary ply 112 is formed by joining a plurality of primary plies 111 cut into a short size and hence, the secondary ply 112 includes a plurality of joint portions 112A where the short primary plies 111 are joined to each other. Further, also at the time of winding the belt forming member 113 into a circular cylindrical shape, it is necessary to join end portions 113a in the tire circumferential direction to each other. Accordingly, the belt 100 includes the joint portions 112A (cut joints) formed in the cutting step, and a joint portion 113A (forming joint) formed in the forming step.

It is not easy to bring these joint portions 112A, 113A into contact with each other and to join these joint portions 112A, 113A to each other over a joint length and hence, irregularities in shape are liable to occur in the joint portions 112A, 113A. Accordingly, the uniformity of the tire is liable to be lowered due to the inclusion of the plurality of joint portions 112A, 113A in the tire.

Further, according to the latter method, it is possible to make the cut joints formed in the cutting step unnecessary. However, in the forming step, the strip-like rubber-coated cord member is wound in a spiral manner over a range from one edge side to the other edge side in a belt width direction. Accordingly, the method requires a considerable amount of time and hence, the belt cannot be formed efficiently.

Accordingly, it is difficult for the conventional belt forming methods to enhance the uniformity of the tire while efficiently forming the belt.

It is an object of the present invention to provide a method of manufacturing a pneumatic tire and a pneumatic tire by which the uniformity of the tire can be enhanced while efficiently forming a belt.

All aspect of the present invention provides a method of manufacturing a pneumatic tire comprising a belt which includes a belt cord extending in a direction inclined with respect to a tire circumferential direction at a cord angle θ and which is wound with a belt-under diameter D and disposed outside a carcass ply in a tire radial direction, the method comprising preparing a strip-like rubber-coated cord member where a plurality of belt cords which are arranged approximately parallel to each other in a longitudinal direction are coated with rubber and a width of the strip-like rubber-coated cord member in a lateral direction is πD sin θ cutting the strip-like rubber-coated cord member at the cord angle θ with respect to a longitudinal direction to cut out a belt forming member having a parallelogram, such that the belt forming member includes; circumferential direction sides which extend in a tire circumferential direction in a wound state and are formed as cut portions; and inclined sides which extend parallel to the belt cord and are defined as both side portions of the strip-like rubber-coated cord member in a lateral direction and winding the belt forming member into a circular cylindrical shape and joining the inclined sides which face each other to each other to form the belt.

According to the present invention, the width of the strip-like rubber-coated cord member in a lateral direction is set to πD sin θ and hence, in the belt forming member cut out from the strip-like rubber-coated cord member at the cord angle θ, the length of the circumferential direction side of the belt forming member is equal to the belt-under circumferential direction length πD. With such a configuration, it is unnecessary to connect the plurality of belt forming members such that the length of the circumferential direction sides of the connected belt forming members becomes belt-under circumferential direction length πD or more. Accordingly, the belt formed by winding the belt forming member has no cut joint and hence, the uniformity of the tire can be enhanced. Further, it is unnecessary to form the cut joint and hence, the belt can be formed efficiently and hence, the productivity of the tire can be enhanced.

Preferably, the cord angle θ is not smaller than 6 degrees and not larger than 9 degrees.

With the above-mentioned configuration, the cord angle θ is not smaller than 6 degrees and not larger than 9 degrees, hence the belt can be formed more efficiently. That is, when the cord angle θ is larger than 9 degrees, the width of the strip-like rubber-coated cord member in the lateral direction becomes excessively large. The formation of such a strip-like rubber-coated cord member is difficult and the handling of the strip-like rubber-coated cord member is also not easy. On the other hand, when the cord angle θ is smaller than 6 degrees, the length of the inclined side becomes extremely large and hence, it is not easy to join these inclined sides to each other with high accuracy. Further, it is difficult to cut the belt cord at an acute angle of smaller than 6 degrees. Accordingly, the belt can be more efficiently formed by the cord angle θ set within the above-mentioned range.

Further, by setting the cord angle σ to an angle of not smaller than 6 degrees and not larger than 9 degrees, the belt can be operated as a reinforcement belt where a binding force in a tire radial direction is suitably set.

Preferably, the belt-under diameter D is not smaller than 940 mm and not larger than 960 mm.

With such a configuration, by applying the present invention to the belt having the belt-under diameter D which is not smaller than 940 mm and not larger than 960 min, it is possible to suppress the excessive increase of the width of the strip-like rubber-coated cord member in a lateral direction, and it is also possible to suppress the excessive increase of the cut length.

Another aspect of the present invention provides a pneumatic tire comprising a belt which includes a belt cord extending in a direction inclined with respect to a tire circumferential direction at a cord angle θ and which is wound with a belt-under diameter D and disposed outside a carcass ply in a tire radial direction, wherein the belt is formed of a belt forming member, the belt forming member is formed by being cut out from a strip-like rubber-coated cord member where a plurality of belt cords which are arranged approximately parallel to each other in a longitudinal direction and coated with rubber and has a lateral width of πD sin θ, and in a state where being cut out from the strip-like rubber-coated cord member with respect to the longitudinal direction at the cord angle θ, the belt forming member has a parallelogram in a shape including circumferential direction sides which are formed as cut portions; and inclined sides which are defined as both side portions of the strip-like rubber-coated cord member in a lateral direction and extend parallel to the belt cord, and the belt includes joint portions where the facing inclined sides are brought into contact with each other in a state where the belt forming member is wound into a circular cylindrical shape such that the circumferential direction sides extend along a tire circumferential direction.

The pneumatic tire can have an aspect ratio of not larger than 70% and a nominal section width of not smaller than 365.

According to the method of manufacturing a pneumatic tire and the pneumatic tire of the present invention, the uniformity of the tire can be enhanced while efficiently forming the belt.

### BRIEF DESCRIPTION OF THE DRAWINGS

The foregoing and the other features of the present invent ion will become apparent from the following description and drawing of an illustrative embodiment of the invention in which:

FIG. 1 is a meridian sectional view of a pneumatic tire according to an embodiment of the present invention;

FIG. 2 is a development view of a belt layer;

FIG. 3A and FIG. 3B are views for schematically describing a method of cutting out the belt forming member from a raw fabric;

FIG. 4A and FIG. 4B are views for schematically describing a method of forming a belt by winding the belt forming member;

FIG. 5 is a schematic partial sectional view of the pneumatic tire when a load is applied to the tire;

FIGS. 6A-6E are views for describing a conventional belt forming method.

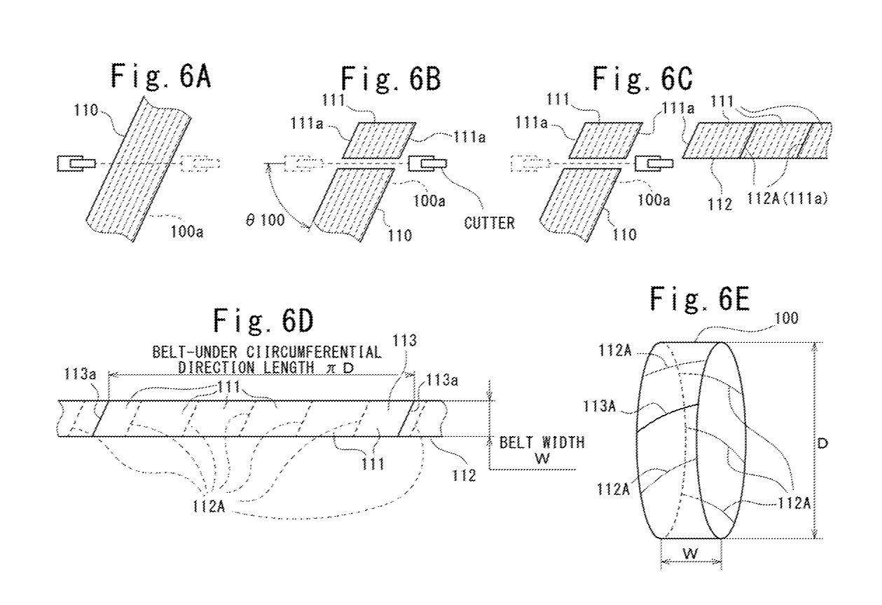

### DETAILED DESCRIPTION OF THE INVENTION

Hereinafter, an embodiment of the present invention is described with reference to attached drawings.

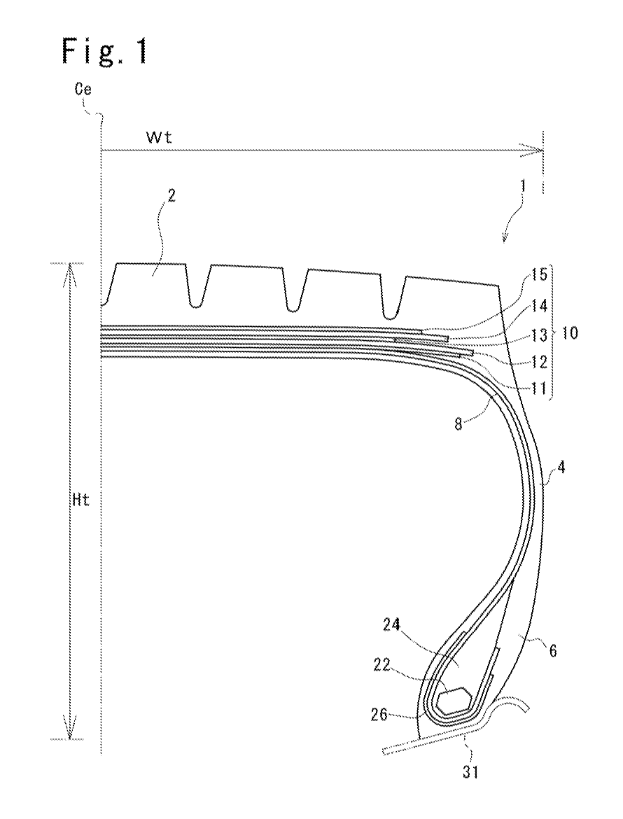

FIG. 1 shows a rubber pneumatic tire (hereinafter referred to as “tire”) 1 according to an embodiment of the present invention. The tire 1 is a pneumatic radial tire for a heavy load used for a vehicle such as a truck or a bus. Further, the tire 1 is a low-profile tire having an aspect ratio of not larger than 70%. An aspect ratio is defined as a ratio of a maximum tire-section height Ht to a maximum tire-section width Wt. Specifically, a size of the tire 1 in this embodiment is 445/50R22.5 (expressed in accordance with ISO standard).

The tire 1 includes a tread portion 2, a pair of side portions 4, and a pair of bead portions 6. The bead portions 6 are respectively formed on inner edge portions of the side portions 4 in a tire-radial direction (edge portions of the side portions 4 opposite to the tread portion 2). A carcass 8 is arranged between the pair of bead portions 6. An inner liner (not shown in the drawing) is arranged in an innermost peripheral surface of the tire 1. A belt layer 10 is arranged between the carcass 8 and a tread surface of the tread portion 2. In other words, in the tread portion 2, the belt layer 10 is arranged at an outer side of the carcass 8 in the tire-radial direction. As described later in detail, in this embodiment, the belt layer 10 includes five belts 11 to 15.

The bead portion 6 includes a bead core 22, a bead filler 24, and a chafer 26. Around the bead core 22, an end portion of the carcass 8 in atire-width direction is wound up from an inner side to art outer side in a tire-width direction along the bead filler 24. The chafer 26 is arranged around the bead filler 24 so as to be arranged adjacently to an outer side of the end portion of the carcass 8.

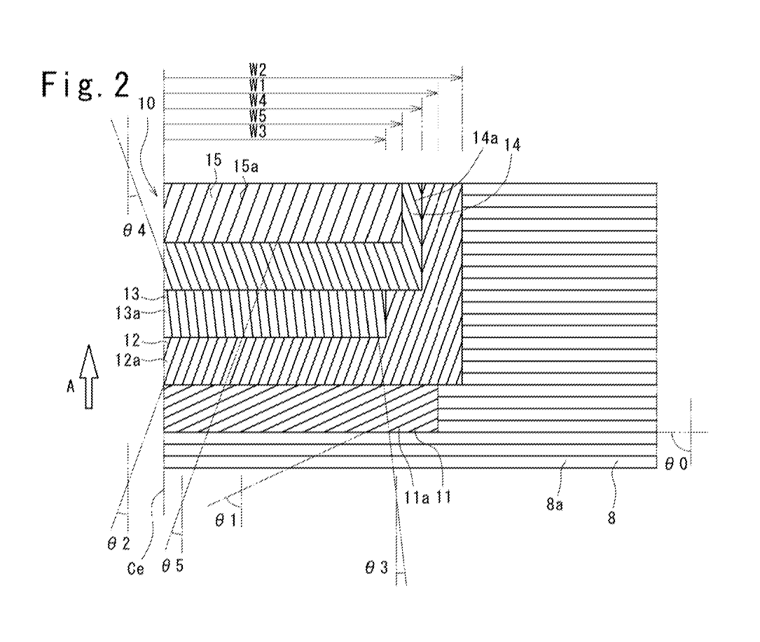

Referring to FIGS. 1 and 2, the carcass 8 in this embodiment is formed of one carcass ply, and is formed of a plurality of carcass cords 8a arranged parallel to each other and coated by a rubber layer. Each carcass cord 8a is arranged so as to extend in the tire-radial direction, and has an angle θ0 with respect to a tire-circumferential direction (cord angle) set to 90 degrees. In FIGS. 1 and 2, symbol Ce indicates a center line in the tire-width direction. The direction along which the center line Ce extends is a tire-radial direction. While the carcass cord 8a in this embodiment is made of steel, the carcass cord 8a can be made of organic fibers.

Referring to FIGS. 1 and 2, the belt layer 10 in this embodiment includes five belts arranged in an overlapping manner. These belts include a buffer belt 11, a first main working belt 12, a reinforcement belt 13, a second main working belt 14, and a protection belt 15.

The buffer belt 11 is arranged adjacently to an outer side of the carcass 8 in the tire-radial direction. The first main working belt 12 is arranged adjacently to an outer side of the buffer belt 11 in the tire-radial direction. The second main working belt 14 is arranged at an outer side of the first main working belt 12 in the tire-radial direction. The reinforcement belt 13 is arranged between the first main working belt 12 and the second main working belt 14. That is, the reinforcement belt 13 is arranged adjacently to the outer side of the first main working belt 12 in the tire-radial direction, and is also arranged adjacently to an inner side of the second main working belt 14 in the tire-radial direction. The protection belt 15 is arranged adjacently to an outer side of the second main working belt 14 in the tire-radial direction.

Main functions of the first and second main working belts 12 and 14 are to apply a binding force in the tire-radial direction to the carcass 8 (with a cord angle θ0 being set to 90 degrees). A main function of the reinforcement belt 13 is to compensate for the shortage in a binding force in the tire-radial direction which is applied to the tire 1 by the first and second main working belts 12 and 14. A main function of the protection belt 15 is to enhance external damage resistance of the tire 1 by protecting the first and second main working belts 12 and 14. A main function of the buffer belt 11 is to enhance impact resistance of the tire 1.

Each of these belts 11 to 15 is formed of a plurality belt cords 11a, 12a, 13a, 14a, and 15a arranged parallel to each other with extending in a direction inclined with respect to a tire circumferential direction and coated by a rubber layer.

Referring FIG. 2, inclination angles (cord angles) θ1 to θ5 of the belt cords 11a to 15a belts 11 to 15 forming the belt layer 10 will be described. In the description hereinafter, regarding the cord angles θ1 to θ5, a direction along which the belt cords 11a to 15a extend rightward and away from the center line Ce in the tire-width direction when an arrow A in FIG. 2 is set as a reference direction can be referred to as “right upward direction”. Similarly, a direction along which the belt cords lla to 15a extend leftward and away from the center line Ce in the tire-width direction when the allow A in FIG. 2 is set as the reference direction can be referred to as “left upward direction”.

In this embodiment, the cord angle θ2 of the belt cord 12a of the first main working belt 12 is set to 17 degrees (right upward direction). The cord angle θ2 can be set to any value which falls within a range of 20±10 degrees, and can preferably be set to a value which falls within a range of 17±5 degrees.

In this embodiment, the cord angle θ4 of the belt cord 14a of the second main working belt 14 is set to 17 degrees (left upward direction). The cord angle θ4 can be set to a value which falls within a range of 20±10 degrees, and can preferably be set to a value which falls within a range of 17±5 degrees.

The cord angles θ2 and θ4 of the first and second main working belts 12, 14 are set so that the belt cords 12a and 14a extend in different directions with respect to the center line Ce in the tire-width direction. That is, one of the cord angles θ2 and θ4 is set so that the belt cords extend in the right upward direction, and the other of them is set so that the belt cords extend in the left upward direction.

The cord angle θ3 of the belt cord 13a of the reinforcement belt 13 is set to 7 degrees (left upward direction) in this embodiment. The cord angle θ3 can be set to a value which falls within a range of not smaller than 6 degrees and not larger than 9 degrees.

The cord angle θ1 of the belt cord 11a of the buffer belt 11 is set to 65 degrees in this embodiment. The cord angle θ1 can be set to a value which falls within a range of 60±15 degrees.

The cord angle θ5 of the belt cord 15a of the protection belt 15 is set to 20 degrees in this embodiment. The cord angle θ5 can be set to a value which falls within a range of 20±10 degrees.

Numerical values (including upper and lower limit values of a numerical value range) of the cord angles θ1 to θ5 can include substantially unavoidable errors, and are not necessarily geometrically precise values as long as that functions required for the belts 11 to 15 are satisfied. This is also applied to the cord angle θ0 of the carcass cords 8a.

The cord angles θ1 to θ5 of the belts 11 to 15 can be coordinated as shown in the following Table 1.

TABLE 1

| | Embodiment | Settable range of angle |
|---|---|---|
| Buffer belt | 65 degrees | 60 ± 15 degrees |
| | (right upward | (right upward direction) |
| | direction) | |
| First main working belt | 17 degrees | 20 ± 10 degrees |
| | (right upward | (17 ± 5 degrees) |
| | direction) | (right upward direction) |
| Reinforcement belt | 7 degrees | Not smaller than 6 degrees |
| | (left upward | and not larger than |
| | direction) | 9 degrees |
| Second main working belt | 17 degrees | 20 ± 10 degrees |
| | (left upward | (17 ± 5 degrees) |
| | direction) | (left upward direction) |
| Protection belt | 20 degrees | 20 ± 10 degrees |
| | (right upward | (right upward direction) |
| | direction) | |

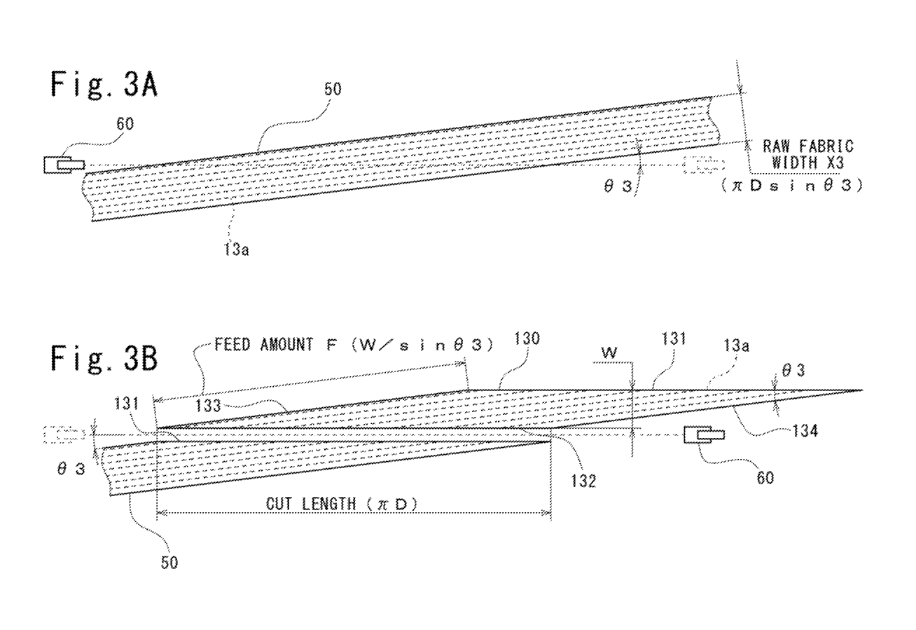

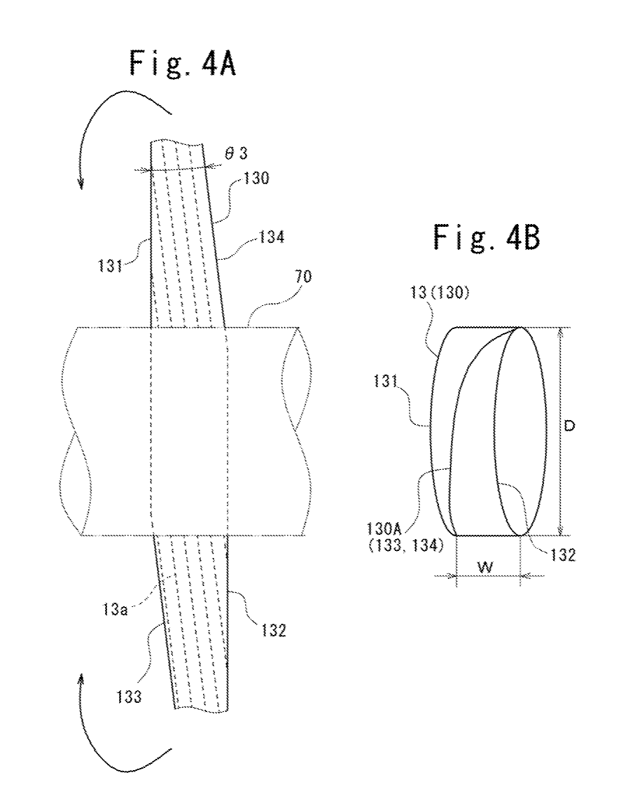

Next, a method of forming a belt is described with reference to FIG. 3 and FIG. 4 by taking the reinforcement belt 13 as an example. Firstly, referring to FIG. 3A, a raw fabric(strip-like rubber-coated cord member) 50 where a plurality of belt cords 13a which are arranged approximately parallel to each other in a longitudinal direction are coated by rubber is prepared. The raw fabric 50 is formed such that a width X3 of the raw fabric in a lateral direction becomes πD sin θ3 when a belt-under diameter of the reinforcement belt 13 is D.

Next, referring to FIG. 3B, in a cutting step, the raw fabric 50 is conveyed in the longitudinal direction by a predetermined feed amount F and, thereafter, the raw fabric 50 is cut in a direction inclined with respect to the longitudinal direction of the raw fabric 50 at a cord angle θ3. Cutting is performed by a cutter 60 capable of moving in a direction inclined with respect to the longitudinal direction of the raw fabric 50 at the cord angle θ3. Thereafter, by sequentially repeating the conveyance and the cutting of the raw fabric 50, a reinforcement belt forming member 130 having a parallelogram is cut out from the raw fabric 50.

The reinforcement belt forming member 130 has first and second sides 131, 132 which are formed by cutting, and third and fourth sides 133, 134 which correspond to both side portions of the raw fabric 50 in a lateral direction, thus having a parallelogram where an angle made by the first side 131 and the fourth side 134 and an angle made by the second side 132 and the third side 133 define the cord angle θ3.

Next, referring to FIG. 4A, as a forming step, the reinforcement belt forming members 130 is wound around a forming drum 70 (indicated by an imaginary line only in FIG. 4A) such that the first and second sides 131, 132 extend parallel to a tire circumferential direction (drum circumferential direction), and the third and fourth sides 133, 134 which face each other are brought into contact with each other and are joined to each other. With such processing, a circular cylindrical-shaped reinforcement belt 13 shown in FIG. 4B is formed.

That is, in a wound state, the reinforcement belt forming members 130 is configured such that the first and second sides 131, 132 form the circumferential direction sides extending in the tire circumferential direction, and a length thereof is a belt-under circumferential direction length πD of the reinforcement belt 13, and the third and fourth sides 133, 134 form the inclined sides extending in a direction inclined with respect to the tire circumferential direction by a cord angle θ3.

Here, a raw fabric width X3 of the raw fabric 50 is set to π sin θ3 and hence, a length of each of the first and second sides 131, 132 which form cut portions formed by cutting the raw fabric 50 in a direction inclined with respect to the longitudinal direction of the raw fabric 50 by a cord angle θ3 becomes πD. That is, by winding the first and second sides 131, 132 around the forming drum 70 by one turn, the reinforcement belt 13 haying a belt-under diameter D is formed. Further, a feed amount P of the reinforcement belt 13 is set to W/sin θ3 and hence, a distance between the first side 131 and the second side 132 becomes a belt width W.

With respect to the reinforcement belt 13 formed in this manner, in the cutting step, it is unnecessary to form short members as primary members for forming the reinforcement belt forming member 130 and hence, it is unnecessary to connect the plurality of short members to each other. Therefore, cut joints which are formed in the cutting step do not exist in the reinforcement belt 13, and only the forming joints 130A in the forming step exist. Accordingly, the number of joint portions in the reinforcement belt 13 can be decreased and hence, the uniformity of the tire can be enhanced. Further, the cut joints become unnecessary and hence, the belt can be formed efficiently whereby the productivity of the tire can be enhanced.

The belt-under diameter D is preferably not smaller than 940 mm and not larger than 960 mm. By setting the belt-under diameter D to a value which falls within such a range, it is possible to suppress the excessive increase of the width of the raw fabric 50 in a lateral direction and hence, it is possible to form the belt more efficiently.

Although the description has been made by taking the reinforcement belt 13 having a relatively small cord angle θ as an example, other belts 11, 12, 14, 15 in the belt layer 10 can be also formed suitably by the method of the present invention. Table 2 shows main data other than cord angles of the belts 11 to 15 according to this embodiment. Table 3 shows main data of raw fabrics and belt forming members for forming these belts 11 to 15.

TABLE 2

| | | | Cord | | |
|---|---|---|---|---|---|
| | | | thickness | | |
| | | | including | | |
| | | | coating | | |
| | | Cord | rubber | End | |
| | Raw | diameter | thickness | number | Belt width |
| | material | (mm) | (mm) | (EPI) | W (mm) |
| Buffer belt | Steel | 1.1 | 1.7 | 12 | W1 = 345 |
| First main | Steel | 1.4 | 2.6 | 12 | W2 = 370 |
| working belt | | | | | |
| Reinforcement | Steel | 1.1 | 1.7 | 12 | W3 = 290 |
| belt | | | | | |
| Second main | Steel | 1.4 | 2.6 | 12 | W4 = 325 |
| working belt | | | | | |
| Protection belt | Steel | 1.1 | 1.9 | 9 | W5 = 295 |

TABLE 3

| | | | | Feed | Cutting |
|---|---|---|---|---|---|
| | | Belt-under | Raw fabric width | amount F | length |
| | | diameter | X (mm) | (mm) W/ | (mm) |
| | Cord angle θ | D (mm) | πDsinθ | sinθ | πD |
| Buffer belt | 65 degrees | 941 | 2680 | 381 | 2957 |
| First main working belt | 17 degrees | 945 | 868 | 1266 | 2968 |
| Reinforcement belt | 7 degrees | 950 | 364 | 2380 | 2985 |
| Second main working | 17 degrees | 953 | 876 | 1112 | 2995 |
| belt | | | | | |
| Protection belt | 20 degrees | 959 | 1030 | 863 | 3012 |

As shown in Table 3, the belt-under diameters of the belts 11 to 15 are set to values not smaller than 940 mm and not larger than 960 mm, and cord angles θ1 to θ5 are made to largely differ from each other, The buffer belt 11 has a large cord angle θ1 and hence, a raw fabric width X1 of the buffer belt 11 is largely increased to 2680 mm. Cord angles θ2, θ4 of the first and second main working belts 12, 14 are each set to 17 degrees so that the cord angles θ2, θ4 are smaller than the cord angle θ1 of the buffer belt 11. Accordingly, raw fabric widths X2, X4 each become approximately 870 mm respectively. In the same manner, a cord angle θ5 of the protection belt 15 becomes 20 degrees, and a raw fabric width X5 becomes approximately 1000 mm.

To the contrary, the cord angle θ3 of the reinforcement belt 13 is set to 7 degrees. That is, the cord angle θ3 is smaller than cord angles of other belts 11, 12, 14, 15 and hence, a raw fabric width X3 is also small, that is, approximately 360 mm. Accordingly, the smaller the cord angle, the smaller the raw fabric width X becomes and hence, the raw fabric 50 can be easily formed and, at the same time, the handling of the raw fabric 50 becomes easy so that the belt can be formed more efficiently.

On the other hand, a feed amount F in the forming the reinforcement belt 13 is increased compared to feed amounts P in forming the other belts 11, 12, 14, 15. In this embodiment, the feed amount F is also a length of a forming joint in the forming step. That is, the forming joint 130A of the reinforcement belt 13 extends in a direction inclined with respect to the tire circumferential direction by a cord angle θ3. Accordingly, when the cord angle θ3 is small, a length of the forming joint 130A is increased. Accordingly, when the cord angle is excessively small, a length of a joint portion is excessively increased and hence, it is not easy to join the inclined sides to each other with high accuracy over the length of the forming joint. Further, when the cord angle is small, in the cutting step, the raw fabric 50 is cut in an inclined manner with respect to the belt cord at an excessively acute angle and hence, it is not easy to cut the raw fabric 50.

As has been described heretofore, to carry out the present invention more efficiently, it is preferable to apply the present invention to a belt where a cord angle is set to a value of not smaller than 6 degrees and not larger than 9 degrees. In this embodiment, an advantageous effect of the present invention can be acquired more effectively with respect to the reinforcement belt 13. However, by applying the present invention also to the other belts 11, 12, 14, 15, cut joints formed in the cutting step become unnecessary and hence, the uniformity of the tire can be enhanced while the belt is formed efficiently.

As shown in Table 2, in this embodiment, a width W4 (325 mm) of the second main working belt 14 which is arranged relatively outer side in the tire-radial direction is set narrower than a width W2 (370 mm) of the first main working belt 12 which is arranged relatively inner side in the tire-radial direction.

A width W3 of the reinforcement belt 13 is set to a value equal to or wider than 50% of a maximum tire-section width Wt (W3≧0.5 Wt). In this embodiment, the maximum tire-section width Wt is a value set under conditions where the tire 1 is mounted on a predetermined rim (a rim 31 is schematically shown in FIG. 1), the tire 1 is filled with air until an inner pressure reaches a predetermined internal pressure (830 kPa which is an internal pressure determined by the Tire and Rim Association, Inc (TRA)), and the tire 1 is in an unloaded state. The width W3 of the reinforcement belt 13 is set narrower than a width of either one of the first and second main working belts 12 and 14 having a narrower width than the other (W3<W2, W4). In this embodiment, the width W3 of the reinforcement belt 13 is set to 290 mm. Accordingly, the width W3 of the reinforcement belt 13 is equal to or wider than 50% of a maximum tire-section width Wt (440 mm) under the above-mentioned conditions, and is narrower than the width W4 (325 mm) of the second main working belt 14 having a narrower width.

The cord angle θ3 of the reinforcement belt 13 is not smaller than 6 degrees and not larger than 9 degrees, instead of a small angle of not smaller than 0 degrees to not more than 5 degrees (an angle which can be substantially regarded as 0 degrees or an angle close to 0 degrees). Such configuration can prevent a binding force in a tire-radial direction generated by a reinforcement belt 13 from becoming excessively large, and therefore the excessively large deformation of the tire in the tire-width direction can be suppressed. Since the excessively large deformation of the tire in the tire-width direction can be suppressed, the distortion generated in the bead portion 6 can be suppressed, and therefore bead durability (resistance against the generation of a defect such as separation in the bead portion can be enhanced.

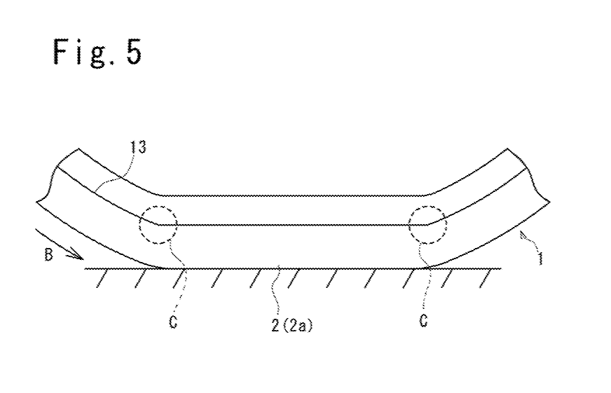

As conceptually shown in FIG. 5, in a loaded state (a state where the tire 1 is mounted on a vehicle), belt cords 13a of the reinforcement belt 13 are bent in regions (symbols C) of a tread surface of the tread portion 2 in front of and behind a road contact surface 2a in the rotational direction of the tire indicated by an arrow B. The smaller cord angle θ3, the more conspicuous the bending of the belt cords 13a becomes. By setting the cord angle θ3 to a value not smaller than 6 degrees and not larger than 9 degrees, compared to a case where the cord angle θ3 is set to a small angle such as an angle not smaller than 0 degrees and not larger than 5 degrees, bending of the belt cord 13a of the reinforcement belt 13 in the vicinity of the road contact surface 2a can be alleviated, and therefore cord breakage can be effectively prevented.

As described above, the width W3 of the reinforcement belt 13 is set narrower than the width W4 of the second main working belt 14 which is narrower one of the first and second main working belts 12, 14. Such configuration can also effectively prevent cord breakage of the belt cord 13a of the reinforcement belt.

As described above, the reinforcement belt 13 is arranged between the first main working belt 12 and the second main working belt 14. Due to such an arrangement, the reinforcement belt 13 is protected by the first and second main working belts 14, and therefore cord breakage of the belt cord 13a of the reinforcement belt 13 caused due to bending of the cord in the vicinity of the road contact surface 2a (symbols C in FIG. 3) can be effectively prevented.

Due to these reasons, cord breakage of the reinforcement belt 13 can be effectively prevented.

By setting the cord angle θ3 of the reinforcement belt 13 to a value not smaller than 6 degrees and not larger than 9 degrees, an effect of suppressing a growth of the tire 1 in the radial direction is reduced compared to the case where the cord angle θ3 is set to a value not smaller than 0 degrees and not larger than 5 degrees. However, the cord angle θ3 of the reinforcement belt 13 is 9 degrees at maximum, and therefore there is no possibility that a binding force in the tire-radial direction is excessively reduced. Further, as described above, the width W3 of the reinforcement belt 13 is equal to or wider than 50% of a maximum tire-section width Wt. That is, a width of the reinforcement belt 13 is not narrow but is sufficiently wide. Due to these reasons, the tire 1 can ensure a required effect of suppressing a growth of the tire 1 in the radial direction. Further, the tire can acquire a sufficient force for holding a shape of the tread portion 2 so that distortion at the end portion of the belt can be reduced whereby the tire can ensure required belt durability. The width W3 of the reinforcement belt 13 is narrower than a width of the narrower one of the first and second main working belts 12 and 14 (widths W2, W4), Accordingly, the distortion generated in the reinforcement belt 13 can be reduced.

As described above, according to the tire 1 of the present embodiment, bead durability can be enhanced while an effect of suppressing a growth of the tire 1 in the radial direction and belt durability are also ensured,

The tire according the present invention is favorably applicable to a pneumatic tire so-called super single tire) having an aspect ratio of not larger than 70% and a nominal section width of not smaller than 365. The tire according to the present invention is also applicable to a pneumatic tire having a small aspect ratio and falling outer side a range of a pneumatic radial tire for heavy load.

What is claimed is:

1. A method of manufacturing a pneumatic tire comprising a belt which includes a belt cord extending in a direction inclined with respect to a tire circumferential direction at a cord angle θ and which is wound with a belt-under diameter D and disposed outside a carcass ply in a tire radial direction, the method comprising:
preparing a strip-like rubber-coated cord member where a plurality of belt cords which are arranged approximately parallel to each other in a longitudinal direction are coated with rubber and a width of the strip-like rubber-coated cord member in a lateral direction is π D sin θ;
cutting the strip-like rubber-coated cord member at the cord angle θ with respect to a longitudinal direction to cut out a belt forming member having a parallelogram, such that the belt forming member includes: circumferential direction sides which extend in a tire circumferential direction in a wound state and are formed as cut portions; and inclined sides which extend parallel to the belt cord and are defined as both side portions of the strip-like rubber-coated cord. member in a lateral direction;
winding the belt forming member into a circular cylindrical shape; and
joining the inclined sides which face each other to each other to form the belt.

9.

1. The method of manufacturing a pneumatic tire according to claim 1, wherein the cord angle θ is not smaller than 6 degrees and not larger than 9 degrees. The method of manufacturing a pneumatic tire according to claim 1, wherein the belt-under diameter D is not smaller than 940 mm and not larger than 960 mm.

4. A pneumatic tire comprising a belt which includes a belt cord extending in a direction inclined with respect to a tire circumferential direction at a cord angle θ and which is wound with a belt-under diameter D and disposed outside a carcass ply in a tire radial direction,
wherein the belt is formed of a belt forming member,
the belt forming member is formed by being cut out from a strip-like rubber-coated cord member where a plurality of belt cords which are arranged approximately parallel to each other in a longitudinal direction and coated with rubber and has a lateral width of π D sin θ, and
in a state where being cut out from the strip-like rubber-coated cord member with respect to the longitudinal direction at the cord angle θ, the belt faulting member has a parallelogram in a shape including circumferential direction sides which are formed as cut portions; and inclined sides which are defined as both side portions of the strip-like rubber-coated cord member in a lateral direction and extend parallel to the belt cord, and
the belt includes joint portions where the facing inclined sides are brought into contact with each other in a state where the belt forming member is wound into a circular cylindrical shape such that the circumferential direction sides extend along a tire circumferential direction.

5. The pneumatic tire according to claim 4, wherein the pneumatic tire has an aspect ratio of not larger than 70% and a nominal section width of not smaller than 365.
